(19) United States
(12) Patent Application Publication
(10) Pub. No.: US 2008/0068995 A1
(43) Pub. Date: Mar. 20, 2008

(54) Devices and Methods for Push Message Initiated Service

(76) Inventor: Robert Skog, Hasselby (SE)

Correspondence Address: ERICSSON INC., 6300 LEGACY DRIVE, M/S EVR 1-C-11, PLANO, TX, 75024, US

(21) Appl. No.: 11/571,635

(22) PCT Filed: Jul. 5, 2004
(86) PCT No.: PCT/SE04/01086

§ 371 Date: Jan. 4, 2007

(51) Int. Cl. H04L 12/26

(52) U.S. Cl. 370/230.1

(57) ABSTRACT

The present invention relates to a mobile communication terminal (102a), a method in a mobile communication terminal, a network node (106a) and a method in network node which allows a service provider to influence the quality of service that is requested for a bearer service for delivery of a service to a mobile client terminal (102a), where the service is initiated by a push message (309) from the service provider and the set-up of the bearer service is initiated (304) by the client terminal after reception of the push message. According to the present invention the push message (309) contains, not only an indication of a service content to be delivered to the client terminal (102a), but also a set of quality of service parameters that the service provider recommends for the bearer service for reception of the service content. Thereby the client terminal (102a) may take the recommendation of the service provider into account when requesting set-up of the bearer service.

### CROSS-REFERENCE TO RELATED APPLICATIONS

This application is related to commonly-assigned co-pending international patent application No. PCT/SE04/______, entitled “Binding Mechanism for Quality of Service Management in a Communication Network”, filed on Jul. 5, 2004; international patent application No. PCT/SE04/______, entitled “Methods and Devices for Supplying Quality of Service Parameters in HTTP Message”, filed on Jul. 5, 2004; and international patent application No. PCT/SE04/______, entitled “Methods and Devices for Changing Quality of Service”, filed on Jul. 5, 2004, the disclosures of which are incorporated herein by reference.

### FIELD OF THE INVENTION

The present invention relates to equipment and methods in mobile communication systems, and more particularly, to controlling quality of service requests for transmissions relating to a packet data service.

### BACKGROUND

Communication networks for packet based communication of information in the form of data bits are well known to the person skilled in the art. The growing importance of mobile communication creates the demand to transfer data over wireless connections. Wireless Application Protocol (WAP) defines a set of protocols to enable operators and manufacturers to provide applications that operate over wireless communication networks. One example of a service that is possible to provide via the WAP architecture is WAP Push, which is a service to push content to mobile devices.

The “push” technology implies that a server in a client/server model transmits information to a client without any explicit request from the client. This differs from “pull” technology which is typically used e.g. for browsing the World Wide Web, where the client requests a service or information from the server, which then responds by transmitting information to the client. In other words “pull” transactions of information are initiated from the client, whereas “push” transactions are server-initiated.

In a WAP Push operation a Push Initiator (PI) transmits a push content and delivery instructions to a Push Proxy Gateway (PPG), which then delivers the push content to a WAP client, such as a mobile phone or some other kind of terminal with WAP capabilities, according to the delivery instructions.

The PI may be an application that runs on an ordinary web server. The PI communicates with the PPG using the Push Access Protocol (PAP), while the PPG uses the Push Over-The-Air (OTA) Protocol to deliver the push content to the client. More information about the WAP Push framework can be found in the document “WAP Push Architectural Overview, Version 03-Jul.-2001”, published on the WAP Forum™ Web site (http://www.wapforum.org).

As explained in the above mentioned document it is often necessary for the client to activate the bearer for the delivery of the push content. For this purpose the client comprises an application that listens to Session Initiation Requests (SIR) from the PPG, and responds by activating the bearer service that the terminal considers appropriate and then contacting the desired PPG. The SIR is typically sent to the client using connectionless push and is e.g. fitted in a single SMS.

The WAP push framework allows any MIME media type to be delivered between the PI and the client. Some specific media types have also been defined specifically to add capabilities not already provided by existing MIME types. One example of such a specific media type is the Service Indication (SI) media type, which provides the ability to send notifications to clients in an asynchronous manner. The notifications may for instance be about new, e-mails, changes in stock price or score in a soccer game, news headlines, advertising, reminders of e.g. low prepaid balance, etc. A basic SI contains a short message and a Uniform Resource Identifier (URI) indicating a service.

The message is sent to an appropriate application in the client and is presented to the end-user upon reception. The user is given the choice to either start the service indicated by the URI immediately, or postpone the SI for later handling. When the user chooses to start the service indicated by the URI the application initiates set-up of a bearer service according to the requirements that are specified for the service in the terminal.

Another example of a media type that is specifically defined for push is the Service Loading (SL) media type. Unlike SI, the SL does not imply any user involvement. The SL includes a URI that points to some content that is loaded by the client without end-user confirmation and an instruction whether the content should be executed/rendered or placed in a cache memory. After reception of the SL in an application in the client terminal, the receiving application initiates set-up of a bearer service for delivery of the content from the PI to the client. Further information about SL and how SL is coordinated with other activities in the client terminal can be found in the document “Service Loading, Version 31-Jul.-2001”, published on the WAP Forum™ Web site (http://www.wapforum.org).

A common feature for SI and SL is that it is the client that initiates set-up of the bearer service for content delivery even though it is the PI (i.e. the server according to the client/server model) that makes the first service initiation by sending a Service Indication or Service Loading message to the client in order to inform the client of a service content that the PI wishes to deliver to the client. When requesting the set-up of the bearer service the client also requests a particular quality of service (QoS) for the bearer service. The requested QoS for the bearer service is specified by means of a set of QoS parameters. The mapping from application level to the requested bearer QoS is done in the client terminal and depends on the terminal vendor's coding of the terminal. It is therefore possible that the same Service Indication message may result in different bearer QoS when sent to terminals from different vendors. It is also possible that the QoS requested by the client terminal is not at all considered to be appropriate for the service content delivery from the viewpoint of the PI who provides the service.

### SUMMARY OF THE INVENTION

An object of the present invention is to provide devices and methods that allow a service provider of a push message initiated service to influence the selection of quality of service parameters for a bearer service that is set-up for receiving a service content from the service provider in a mobile client terminal.

The above stated object is achieved by means of a mobile communication terminal according to claims 1 and 10, a method in a mobile communication terminal according to claims 11 and 20, a network node according to claim 21 and a method in a network node according to claim 33.

The basic idea of the present invention is to transfer, not only an indication of the service content in the push message by means of which the service provider initiates the service, but also a set of recommended quality of service parameters. Thereby the mobile terminal can retrieve the set of recommended quality of service parameters upon reception of the push message and can take the set of recommended quality of service parameters into consideration when requesting the bearer service for reception of the service content indicated by the push message. Implementation of the basic idea of the present invention requires a new modified mobile terminal, a new modified network node as well as new methods in the mobile terminal and the network node, which are all provided according to different aspects of the present invention.

According to a first aspect of the present invention a mobile communication terminal is provided which comprises an application for receiving at least one packet data service from a service provider. The application is arranged to receive a pushed service indicating message from the service provider, which service indicating message includes information that the service provider has a service content to deliver to the terminal. The application is further arranged to initiate set-up of a bearer service for reception of the service content. The mobile communication terminal further includes processing means for retrieving a set of recommended quality of service parameters that is included in the received service indicating message. The set of recommended quality of service parameters is a set of quality of service parameters that the service provider recommends that the terminal requests for a bearer service for reception of the service content. The processing means are further arranged to process the set of recommended quality of service parameters to determine a set of processed quality of service parameters based on the set of recommended quality of service parameters and to request the set of processed quality of service parameters for the bearer service for reception of the service content.

According to a second aspect the present invention provides a network node in a network for providing a set of packet data services from a service provider to mobile client terminals. The network node comprises message creating means for creating a service indicating message for push transmission to a first client terminal and an interface for pushing the service indicating message to the first client terminal. The message creating means are arranged to include, in the service indicating message, information that the service provider has a service content to deliver to the first client terminal and a set of recommended quality of service parameters, which the service provider recommends that the first client terminal requests for a bearer service for reception of the service content.

According to a third and fourth aspect, the present invention provides a method in a mobile communication terminal and a method in a network node.

An advantage of the present invention is that it allows for the service provider to influence the quality of service parameters that the mobile terminal requests. This may be beneficial since the service provider knows the character of the service content and therefore may be better able than the mobile terminal to decide suitable quality of service parameters for delivery of the service content. The service provider may also want to influence the quality of service parameters that are used in conjunction with one of his services in order to preserve his image and reputation as a service provider who provides good quality services. If too low quality of service is requested by the terminal this may have a bad reflection on the provider of the service content even though the low quality of service was due to the construction of the terminal.

Another advantage of the present invention is that it makes it possible to achieve more uniform quality between different terminals for the same service or type of service. Since the mobile terminal, according to a preferred embodiment of the present invention, may be arranged to request the set of recommended quality of service parameters for the bearer service it is possible to lessen the impact of the coding of the mobile terminal on the quality of service of the bearer service. In prior art solutions the mobile terminal is usually “hard coded” to request a pre-defined PDP context. The coding may vary between different terminal vendors, which may lead to different quality of service for terminals from different vendors.

Yet another advantage of the present invention is that it may allow a flexible determination of the quality of service parameters that are requested for the bearer service. By means of the present invention the mobile terminal does not need to be limited to request the quality of service parameters of just one or a few predefined bearer services.

Further advantages and features of embodiments of the present invention will become apparent when reading the following detailed description in conjunction with the drawings.

### BRIEF DESCRIPTION OF THE DRAWINGS

FIG. 1 is a schematic block diagram illustrating the general network architecture of a mobile communication system in which the present invention may be used.

FIG. 2 is a flow diagram illustrating schematically a service according to the prior art that is initiated by means of a push message from an application server.

FIG. 3 is a flow diagram illustrating schematically a service, which corresponds to the service illustrated in FIG. 2, but for which the present invention is applied.

FIG. 4 is a schematic signaling/flow diagram that illustrates the function of an exemplary embodiment of a network node according to the present invention and an exemplary embodiment of a mobile communication terminal according to the present invention.

FIG. 5 is a schematic signaling/flow diagram that illustrates the function of an alternative exemplary embodiment of a network node according to the present invention and an exemplary embodiment of a mobile communication terminal according to the present invention.

FIG. 6 is a schematic signaling/flow diagram that illustrates the function of yet another alternative exemplary embodiment of a network node according to the present invention and an exemplary embodiment of a mobile communication terminal according to the present invention.

FIG. 7 is a schematic signaling/flow diagram that illustrates the function of a further alternative exemplary embodiment of a network node according to the present invention and an exemplary embodiment of a mobile communication terminal according to the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

The present invention is applicable to packet switched services in a mobile communication system, which services are initiated from a service provider by means of a push message. Such services include packet switched communication between a mobile client terminal of an end-user and an application server. The mobile communication system includes a radio network such as a WCDMA, CDMA2000, Wireless LAN or GPRS network in which the mobile client terminal resides.

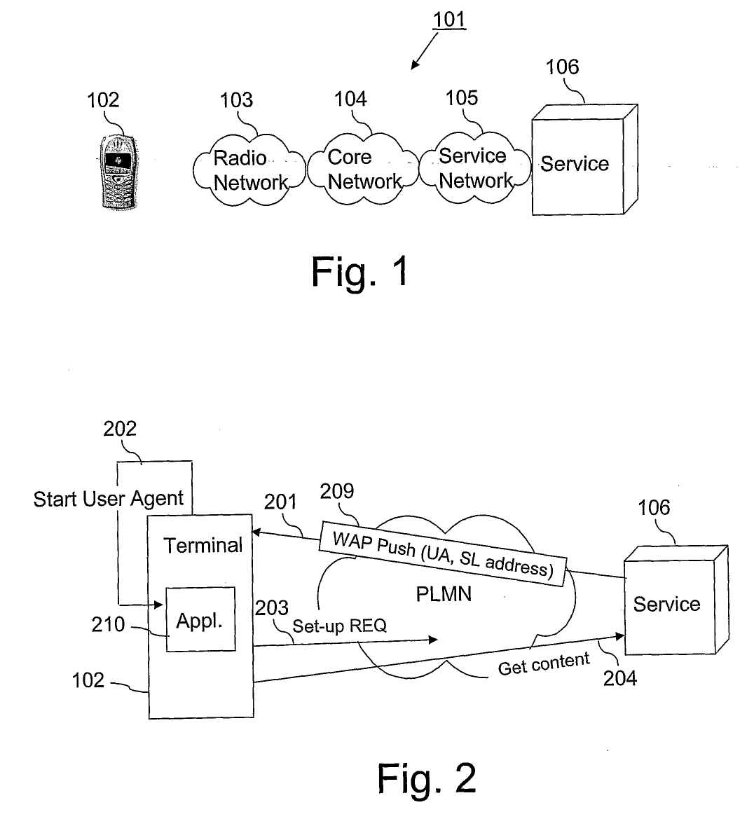

FIG. 1 is a schematic block diagram illustrating the general network architecture of a mobile communication system in which the present invention may be used. The mobile system 101 in FIG. 1 comprises a mobile client terminal 102 which may communicate with a network node 106 of a service provider and thereby receive a service that is offered by the service provider. The communication between the client terminal 102 and the network node 106 is carried out via a radio network 103, a core network 104 and a service network 105. The radio network 103 may for instance be a UTRAN (UMTS Terrestrial Radio Access Network) or CDMA2000 network, the core network 104 may for instance be a UMTS Core Network and the service network may for instance be the Internet or a private IP network of a service provider. The network node 106 of the service provider may for instance be an application server or a Push Proxy Gateway.

FIG. 2 is a flow diagram illustrating schematically a service according to the prior art that is initiated by means of a push message from a network node of a service provider. The service may for instance be a service that allows the user of the mobile client terminal to subscribe to pictures showing soccer goals during the World Championships. When pictures of a new soccer goal are available the service provider will inform the user of the new pictures by means of push message. FIG. 2 illustrates that a network node 106 of the service provider initiates the service by sending a push message 209, step 201, to the mobile client terminal 102. In this example the push message 209 is a WAP Push Service Loading (SL) message that is sent to the mobile client terminal via WAP Push and SMS and the service content, i.e. the pictures, is indicated by a URI included in the SL message. The SL message is addressed to an appropriate user agent or application 210 in the mobile client terminal. In this case we assume that the service is to be delivered on an MMS bearer so the push message is addressed to an MMS agent. When the SL message is received in the mobile client terminal it is forwarded to the targeted user agent 210, which then starts, step 202, and thereafter requests a pre-configured PDP context with an MMS bearer, step 203. When the mobile client terminal has received confirmation that the PDP context has been set up the terminal can get the service content by means of the received URI, step 204.

It is evident from the illustration in FIG. 2 that it is the service provider that initiates the service but it is the client terminal 102 that requests set-up of the bearer service for delivery of the service content. It is therefore the mobile client terminal that requests the PDP context parameters and thereby the quality of service (QoS) of the bearer. Today each user agent or application is combined with a pre-configured PDP context with a selected QoS class which is “hard coded” in the mobile client terminal.

In UMTS (Universal Mobile Telecommunication System) QoS is defined with a set of attributes that specifies the UMTS bearer service. The UMTS QoS attributes are the following:
Traffic class
Maximum bit-rate
Guaranteed bit-rate
Delivery order
Maximum SDU size
SDU format information
SDU error ratio
Residual bit error ration
Delivery of erroneous SDUs
Transfer delay
Traffic handling priority
Allocation/Retention Priority
Source statistics descriptor
Signaling Indication

These attributes can be mapped to the pre-defined UMTS QoS classes: Conversational class, Streaming class, Interactive class and Background class. More detailed information about UMTS QoS can be found in the technical specifications 3GPP TS 23.107 V6.1.0 (2004-03) and 3GPP TS 23.207 V6.2.0 (2004-03).

The QoS classes can be negotiated and managed by using PDP context management. Application level QoS requirements are mapped to PDP context parameters in the mobile client terminal. In prior art solutions pre-configurations of PDP contexts are made in the client terminal such that when a packet switched application starts and connects to the network a matching pre-configured PDP context is activated. This PDP context has a selected QoS class that should match the desired QoS requirements of the application. If for instance the application is a WAP browser or MMS client the QoS class of the activated PDP context is usually the Interactive class.

Thus in the prior art solutions the selection of QoS parameters for the bearer service that is set up for delivery of the service content in the example illustrated in FIG. 2 depends on the terminal vendor's configuration of the mobile client terminal. The service provider cannot influence the selection of the QoS parameters. This is in many instances problematic, especially from the viewpoint of the service provider, but also from a user perspective, when it results in set-up of a bearer service with a QoS that is not appropriate for the delivery of the service content. The service provider is usually interested in being able to ensure that the offered service is delivered with a certain minimum quality. If the quality of service is bad this may have a negative impact on the service provider's reputation even if the bad quality is caused by a network operator or terminal vendor. The user of the service will become annoyed if the QoS is bad and will probably blame the service provider for the bad quality. It is also possible that a user with one terminal gets unacceptably bad QoS when receiving a particular service content while another user, with a terminal from another vendor, gets acceptable QoS when receiving the same service content.

According to the present invention it is possible for the service provider to influence the selection of the QoS parameters of a bearer service that is used for the delivery of a service content of a push message initiated service. This is achieved by means of modifying the push message to also include recommended QoS parameters that the service provider recommends for the bearer service to be set up by the mobile client terminal.

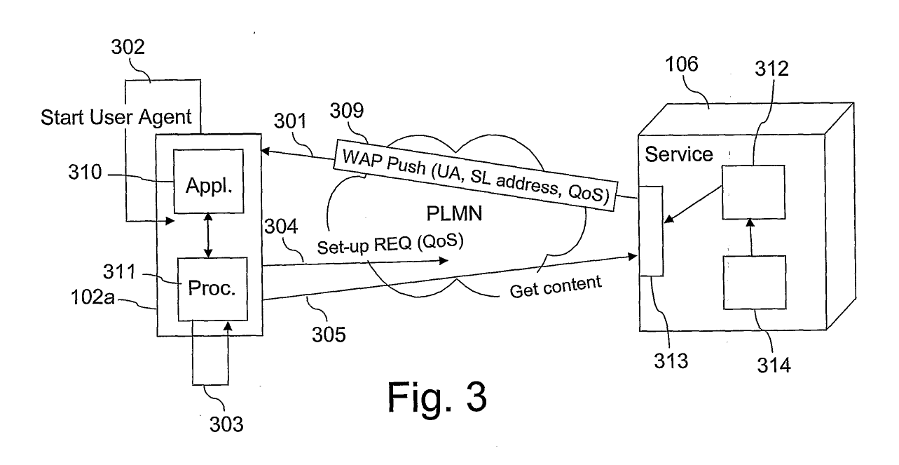

FIG. 3 is a flow diagram illustrating schematically a service, which corresponds to the service illustrated in FIG. 2, but for which the present invention is applied. FIG. 3 illustrates that a network node 106a of the service provider initiates the service by sending a push message 309, step 301, to the mobile client terminal 102a. According to the present invention the push message 309 includes a set of recommended QoS parameters. The push message 309 may for instance be a WAP Push Service Loading (SL) message that has been modified by adding the set of recommended QoS parameters. When the push message 309 is received in the mobile client terminal it is forwarded to the targeted user agent 310, which then starts, step 302. The user agent 310 or supporting software in the mobile client terminal is provided with processing means 311 which then retrieves and processes the set of recommended QoS parameters from the push message to determine PDP context parameters that correspond to the set of recommended QoS parameters, step 303. Thereafter, in step 304, the user agent requests a PDP context with the PDP context parameters that was determined in step 303. When the mobile client terminal has received confirmation that the PDP context has been set up the terminal can get the service content, step 305.

The procedure illustrated in FIG. 3 allows the service provider to influence the QoS of the bearer service instead of relying on “hard coded” QoS parameters inside the mobile client terminal. To implement the procedure of FIG. 3 modifications are necessary on the side of the sender of the push message in order to modify the push message to also include the set of recommended QoS parameters and on the terminal side in order to interpret the modified push message.

A mobile terminal 102a according to the invention is adapted to retrieve and process the set of recommended QoS parameters in the push message 309 that indicates a service content for delivery to the mobile terminal. Such a mobile terminal can be achieved by complementing a prior art terminal with processing means 311 for retrieving the set of recommended QoS parameters from the push message, processing the retrieved set of parameters and requesting QoS for a bearer service based on the retrieved set of parameters. The processing means 311 will according to a preferred embodiment be software code means of the application 310 that the push message 309 targeted. It is also possible that the processing means are software code means of a supporting software function, which is external from the application and which the application calls upon reception of the push message. How to implement such software code means in order for it to be able to perform the functions described herein using common computer languages is well known to the person skilled in the art and will not be explained in further detail.

According to a preferred embodiment of the mobile terminal 102a according to the invention the mobile terminal is arranged to request the same QoS for the bearer service to be set up as is recommended by the service provider by means of the set of recommended QoS parameters in the push message 309. It is however also possible that the mobile terminal processes the set of recommended QoS parameters and decides to request a slightly different QoS for the bearer service. The terminal vendor may for instance implement the mobile terminal to always add a margin to any bandwidth that the service provider recommends. Assume for instance that the push message includes a QoS parameter that indicates that the service provider recommends 64 kb/s guaranteed bit rate for the bearer service. The mobile terminal may then be implemented to add a margin of 2 kb/s when processing the QoS parameters in the push message so that the mobile terminal requests a 66 kb/s guaranteed bit rate for the bearer service. The idea of the invention is thus to allow the mobile terminal to base its QoS request on the QoS that the service provider recommends, but not be completely restricted by it.

The push message 309 may be any type of pushed message from a service provider that initiates a service by means of including information that the service provider has a service content to deliver to the mobile terminal. According to the invention the push message 309 also includes the set of recommended QoS parameters. The push message may for instance be a WAP Push Service Indication message or a WAP Push Service Loading message with the QoS information in the form of the set of recommended QoS parameters added. The information that the service provider ha a service content to deliver to the terminal may for instance be a URI (Uniform Resource Identifier) indicating the service content.

The push message 309 may be pushed to the mobile terminal using different techniques. One technique is to deliver the push message in an SMS. If the mobile terminal already has a primary PDP context established for another service it may be possible to transfer the push message to the terminal 102a over the primary PDP context. The mobile terminal will then request a secondary PDP context for the delivery of the service content indicated by the push message 309.

In some cases it may be advisable to not set up the bearer service for receiving the service content when the push message is received. This may be the case if for instance the terminal is low on battery, is currently roaming or is located abroad and the user's subscription does not support service delivery abroad. In such cases the mobile terminal 102a may be arranged to reject the offered service by not responding to the push message 309 or to delay the reception of the offered service until for instance the battery has been charged or the terminal is no longer roaming.

On the network side, i.e. the side that creates and sends the push message 309, there are a number of different possible embodiments of the present invention. Different network nodes may be adapted to include the set of recommended QoS parameters in the message to be pushed to the terminal. The QoS information may for instance be provided by an application server, a policy server or a Push Proxy Gateway.

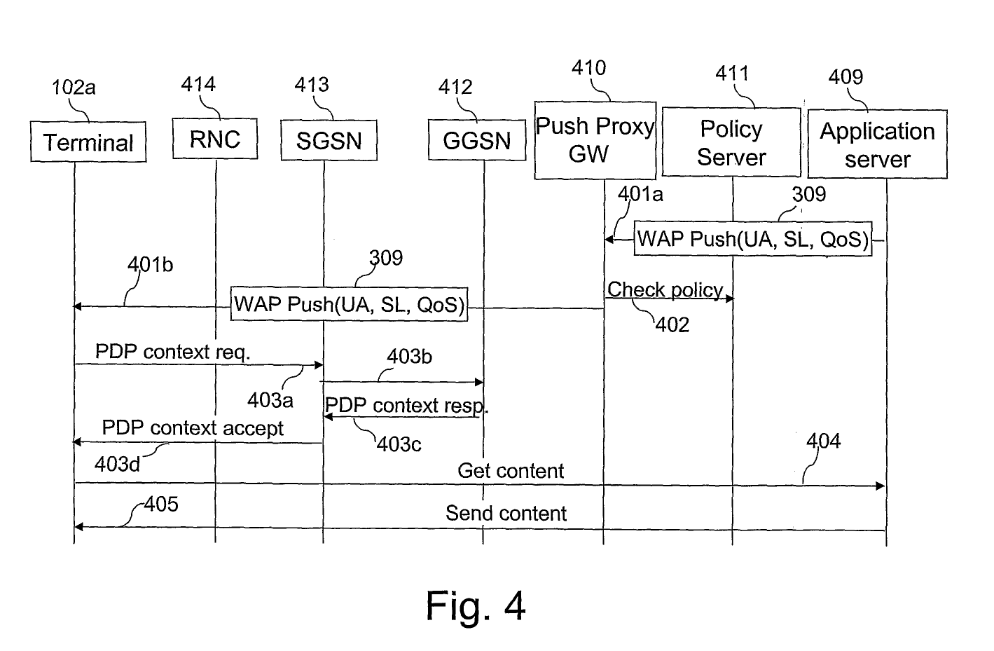

FIG. 4 is a schematic flow diagram that illustrates an example of the situation where an application server 409 inserts the QoS information in the push message 309. In this example the push message is a WAP Push message that is created in the application server 409 that provides the service content for delivery to the terminal 102a. The message 309 includes, according to this embodiment, an indication of the targeted user agent (UA), information of an ordinary WAP Push Service Loading message SL and the set of recommended QoS parameters. The push message 309 is sent to a Push Proxy Gateway 410 in a step 401a. The message may be sent with a modified version of the PAP API (Push Access Protocol Application Programming Interface) defined in the OMA/WAP standard today, see the document “Push Access Protocol, Version 29-Apr.-2001”, published on the WAP Forum™ Web site (http://www.wapforum.org). The API need to be modified to support the inclusion of the set of QoS parameters in the push message. Before forwarding the message to the terminal 102a the Push Proxy Gateway checks with a policy server 411 that the application server 409 is allowed to send the message to the terminal 102a, step 402. After confirmation from the policy server 411 the Push Proxy Gateway 410 forwards the message 309 including the set of recommended QoS parameters to the terminal 102a. The forwarding is in this example performed by means of SMS. As mentioned above the terminal 102a will then start the specified User Agent, process the message and thereafter the User Agent will start a PDP context by sending a request to activate a PDP context to a SGSN (Serving GPRS Support Node) 413 of a UMTS core network via a RNC (Radio Network Controller) 414 of a UTRAN, step 403a. This request will preferably include the set of recommended QoS parameters that was sent in the push message 309. As is well known to the person skilled in the art the PDP context activation then continues with a Create PDP Context request from the SGSN 413 to a GGSN (Gateway GPRS Support Node) 412, a Create PDP context response from the GGSN to the SGSN, and an Activate PDP Context accept from the SGSN to the terminal, steps 403b-d. When the PDP context has been set up the terminal can fetch the service content that was specified in the push message, step 404, and the application server 409 delivers the service content to the terminal in a step 405.

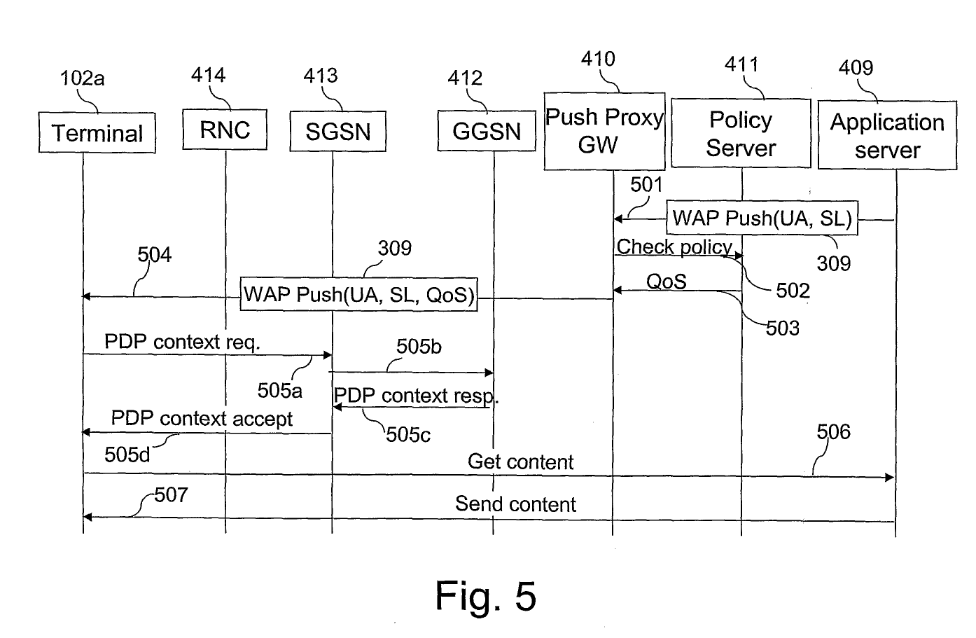

FIG. 5 is a schematic flow diagram that illustrates an example of an alternative embodiment in which the policy server 411 provides the QoS information in the push message 309. In this case the application server 409 sends a WAP Push message to the Push Proxy Gateway 410 in the same way as in prior art solutions, step 501. The Push Proxy Gateway 410 then checks with the policy server that the application server is allowed to send the message to the terminal, step 502. The policy server sends the set of recommended QoS parameters to be forwarded to the terminal in the push message in response, step 503. The Push Proxy Gateway 410 then forwards the message received from the application server with the set of QoS requirements appended to the terminal 102a by means of SMS in a step 504. The remaining steps 505a-d, 506 and 507 illustrated in FIG. 5 are identical to the steps 404a-d, 405 and 406 illustrated in FIG. 4 and explained above.

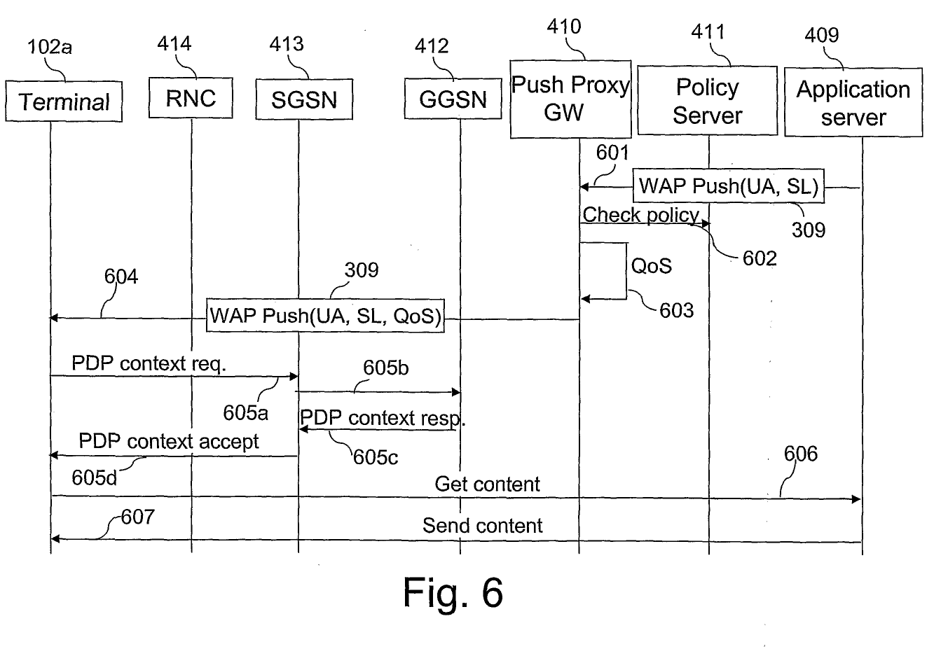

FIG. 6 is a schematic flow diagram that illustrates an example of another alternative embodiment in which the Push Proxy Gateway 410 provides and inserts the QoS information in the push message 309. In this case the application server 409 sends a WAP Push message to the Push Proxy Gateway 410 in the same way as in prior art solutions, step 601. The Push Proxy Gateway 410 then checks with the policy server 411 that the application server is allowed to send the message to the terminal, step 602. After confirmation from the policy server the Push Proxy Gateway determines the set of QoS parameters to be sent to the terminal and inserts the set in the push message that was received from the application terminal, step 603. The Push Proxy Gateway may be implemented to make this determination of QoS parameters based on a set of rules that e.g. depend on the type of service content, the application that provides the service content and/or the network in which the terminal resides. Then the Push Proxy Gateway 410 forwards the created push message with the set of QoS requirements by means of SMS to the terminal 102a in a step 604. The remaining steps 605a-d, 606 and 607 illustrated in FIG. 6 are identical to the steps 404a-d, 405 and 406 illustrated in FIG. 4 and explained above.

From the examples illustrated in FIGS. 4, 5 and 6 it is apparent that different network nodes may be adapted to determine and insert the recommended QoS parameters in the message to be pushed to the terminal. The network node 106a illustrated in FIG. 3 may thus represent e.g. an application server 409, a policy server 411 or a Push Proxy Gateway 410. In order to insert the recommended QoS parameters in the push message 309 the network node will preferably be implemented with software code means 312 that support the creation of the push message that includes the set of recommended QoS parameters. The network node will also have to include an interface 313 for pushing the message to the terminal 102a. The node that is responsible for determining the recommended QoS parameters will have to be provided with means 314 for doing this. Such means may for instance be software code means that define rules or formulas for deriving the recommended QoS parameters based some specific criteria. Such specific criteria on which the recommended QoS parameters may depend may for instance be the type of subscription of the user of the terminal, the type of service content to be delivered to the terminal, the application that delivers the service, time of day or some relevant network information such as network load or geographic location of the terminal.

Different criteria may be possible to consider depending on the node that determines the QoS parameters. If for instance the service provider is CNN, CNN may have an agreement with the network operator to always receive 128 kb/s guaranteed bit rate for its services. In that case the node that determines the recommended QoS parameters may be arranged to determine that, when CNN is delivering the service content, one of the recommended QoS parameters should be 128 kb/s guaranteed bit rate. Another example is when the recommended QoS parameters depend on the subscription of the user of the terminal. Suppose that a first user has a “gold subscription” with a network operator and a second subscription has a “silver subscription” with the network operator. In that case it may be determined by e.g. the policy server that 128 kb/s guaranteed bit rate is a recommended QoS parameter if the push message is to be sent to the first terminal and that 64 kb/s guaranteed bit rate is a recommended QoS parameter if the push message is to be sent to the second user.

It is also possible that several network nodes are involved in determining the set of recommended QoS parameters. The application server may for instance determine a first set of recommended QoS parameters which the policy server then modifies after having checked the subscription of the user of the terminal. The determination of the recommended QoS parameters may also be determined based on a negotiation between several network nodes.

The set of recommended QoS parameters may include a single parameter value or several parameters. The set of recommended QoS parameters may be in the form of explicit parameter values in the form of recommended values for defined UMTS QoS attributes or PDP context parameters. It is also possible that the set of recommended QoS parameters is an indication of a recommended pre-defined UMTS QoS class for which QoS parameters are predetermined.

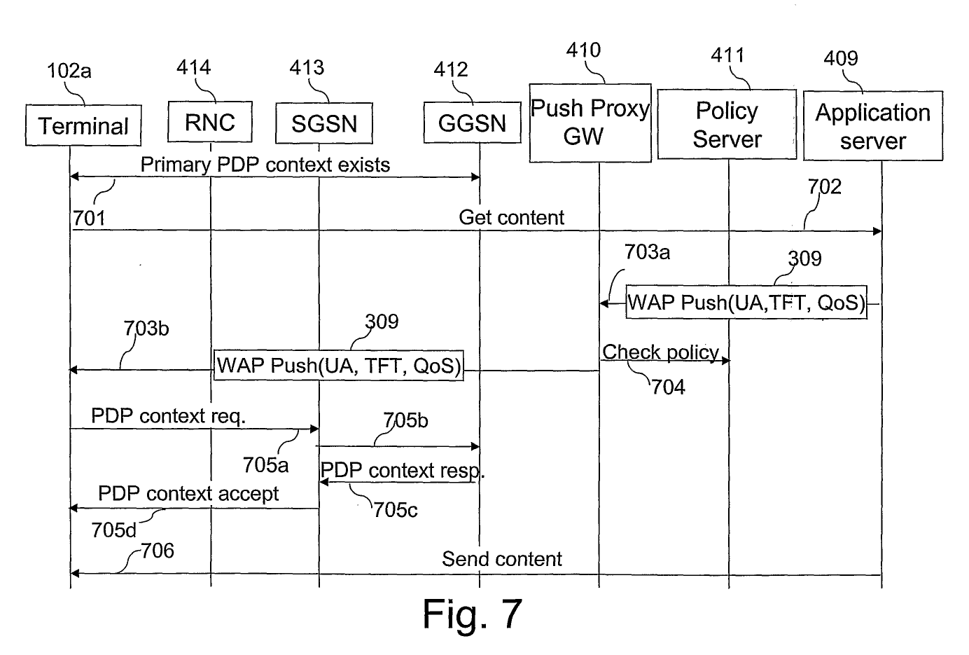

FIG. 7 is a schematic flow diagram that illustrates a scenario in which a primary PDP context 701 exists and the push message 309 is forwarded to the terminal 102a over the primary PDP context. The primary PDP context may have been set-up to enable the user of the terminal to browse the Internet. While browsing the user may indicate that he wishes to listen to an MP3-file, step 702 which causes the application server 409 to send the push message 309 to the Push Proxy Gateway 410, step 703a, in order to initiate set-up of a secondary PDP-context. The Push Proxy Gateway may initiate a policy check, step 704, before forwarding the push message 309 to the terminal 102a. The push message 309 is forwarded to the GGSN 412 using regular IP connectivity and from the GGSN 412 to the terminal 102a over the primary PDP context 701. After processing of the push message 309 and the set of recommended QoS parameters in the terminal 102a, the secondary PDP context is set-up, steps 705a-705d. The service content is then delivered to the terminal 102a over the secondary PDP context, step 706, which allows the user of the terminal to listen to the MP3-file. The illustration of the push message 309 in FIG. 7 shows that the push message includes a TFT (Traffic Flow Template). The TFT is sent in order to provide a mechanism for determining on which of the two PDP-contexts a payload is to be sent, as is well known to the person skilled in the art.

In this application it is mentioned that the set of recommended QoS parameters is a set of QoS parameters that the service provider recommends that the terminal requests for a bearer service for reception of the service content. It should be noted that this phrase is intended to encompass all of the above mentioned examples in which different network nodes determine the recommended QoS parameters based on different criteria. The term “service provider” is thus to be interpreted widely and to encompass e.g. both the provider of the service content and the network operator that provides the network bearer service.

From the exemplary embodiments of the present invention it is clear that the present invention allows a service provider to influence the QoS that a terminal requests for a bearer service for delivery of a service content that was indicated in a push message from the service provider. This is possible since the present invention provides the possibility to include a set of recommended QoS parameters in the push message.

In the drawings and specification, there have been disclosed typical preferred embodiments of the invention and, although specific terms are employed, they are used in a generic and descriptive sense only and not for purposes of limitation, the scope of the invention being set forth in the following claims.

1. A mobile communication terminal comprising:
an application for receiving at least one packet data service from a service provider, said application being arranged to receive a pushed service indicating message from the service provider, said service indicating message including information that the service provider has a service content to deliver to the terminal, and said application being further arranged to initiate set-up of a bearer service for reception of said service content,
said terminal further including processing means for
retrieving a set of recommended quality of service parameters that is included in the received service indicating message, said set of recommended quality of service parameters including a set of quality of service parameters within a bearer that the service provider recommends that the terminal requests for a bearer of the bearer service for reception of the service content;
processing the set of recommended quality of service parameters to determine a set of processed quality of service parameters based on said set of recommended quality of service parameters; and for
requesting the set of processed quality of service parameters for the bearer of the bearer service for reception of said service content.

2. The mobile communication terminal according to claim 1, wherein said set of processed quality of service parameters equals said set of recommended quality of service parameters.

3. The mobile communication terminal according to claim 1, wherein said bearer service is a Packet Data Protocol Context.

4. The mobile communication terminal according to claim 1, wherein said pushed service indicating message is a WAP Push Service Loading message that has been modified by appending the set of recommended quality of service parameters.

5. The mobile communication terminal according to claim 1, wherein said pushed service indicating message is a WAP Push Service Indication message that has been modified by appending the set of recommended quality of service parameters.

6. The mobile communication terminal according to claim 1, wherein said terminal is arranged to receive said pushed service indicating message over a pre-established primary Packet Data Protocol Context and wherein said bearer service for reception of said service content is a secondary Packet Data Protocol Context.

7. The mobile communication terminal according claim 1, wherein the information that the service provider has a service content to deliver to the terminal comprises a Uniform Resource Identifier, URI, indicating the service content.

8. The mobile communication terminal according to claim 1, wherein said set of recommended quality of service parameters comprises an indication to a pre-defined UMTS QoS class.

9. The mobile communication terminal according to claim 1, wherein said set of recommended quality of service parameters comprises a recommended value for at least one UMTS QoS attribute.

10. A mobile communication terminal comprising:
an application for receiving at least one packet data service from a service provider, said application being arranged to receive a pushed service indicating message from the service provider, said service indicating message being information that the service provider has a service content to deliver to the terminal, and said application being further arranged to initiate set-up of a bearer service for reception of said service content, said terminal further including
processing means for
retrieving and processing a set of recommended quality of service parameters that is included in the received service indicating message; and for
requesting the set of processed recommended quality of service parameters for the bearer of the bearer service for reception of said service content.

11. A method in a mobile communication terminal comprising an application for receiving at least one packet data service from a service provider said method comprising the steps of:
the application receiving a pushed service indicating message from the service provider, said service indicating message including information that the service provider has a service content to deliver to the terminal,
retrieving a set of recommended quality of service parameters that is included in the received service indicating message, said set of recommended quality of service parameters including a set of quality of service parameters within a bearer that the service provider recommends that the terminal requests for a bearer of the bearer service for reception of the service content;
processing the set of recommended quality of service parameters to determine a set of processed quality of service parameters based on said set of processed, recommended quality of service parameters; and
the application initiating setup of a bearer service for reception of said service content requesting the set of processed quality of service parameters for the bearer of the bearer service.

12. The method according to claim 11, wherein said set of processed recommended quality of service parameters equals said set of recommended quality of service parameters.

13. The method according to claim 11 wherein said bearer service is a Packet Data Protocol Context.

14. The method according to claim 11, wherein said pushed service indicating message is a WAP Push Service Loading message that has been modified by appending the set of recommended quality of service parameters.

15. The method according to claim 11, wherein said pushed service indicating message is a WAP Push Service Indication message that has been modified by appending the set of processed, recommended quality of service parameters.

16. The method according to claim 11, wherein said pushed service indicating message is received over a pre-established primary Packet Data Protocol Context and wherein said bearer service for reception of said service content is a secondary Packet Data Protocol Context.

17. The method according to claim 11, wherein the information that the service provider has a service content to deliver to the terminal comprises a Uniform Resource Identifier, URI, indicating the service content.

18. The method according to claim 11, wherein said set of recommended quality of service parameters comprises an indication to a pre-defined UMTS QoS class.

19. The method according to claim 11, wherein said set of recommended quality of service parameters comprises a recommended value for at least one UMTS QoS attribute.

20. A method in a mobile communication terminal comprising an application for receiving at least one packet data service from a service provider, said method comprising the steps of:
the application receiving a pushed service indicating message from the service provider, said service indicating message including information that the service provider has a service content to deliver to the terminal;
retrieving a set of recommended quality of service parameters that is included in the received service indicating message, and
the application initiating setup of a bearer service, for reception of said service content, requesting the set of recommended quality of service parameters for the bearer of the bearer service.

21. A network node in a network for providing a set of packet data services from a service provider to mobile client terminals, the network node comprising:
message creating means for creating a service indicating message for push transmission to a first client terminal; and
an interface for pushing the service indicating message to the first client terminal, wherein the message creating means are is arranged to include, in the service indicating message, information that the service provider has a service content to deliver to the first client terminal and characterised in that the message creating means is arranged to include, in the service indicating message, a set of recommended quality of service parameters, which the service provider recommends that the first client terminal requests for a bearer of a bearer service for reception of the service content.

22. The network node according to claim 21, wherein said network node further comprises parameter determining means for determining said set of recommended quality of service parameters based on at least one of the following types of input information:
type of the service content, type of subscription of the user of the terminal information about the network in which the bearer service is to be set up, and provider of the service content.

23. The network node according to claim 21, wherein said set of recommended quality of service parameters is a set of recommended Packet Data Protocol Context quality of service parameters.

24. The network node according to claim 21, wherein said service indicating message is a WAP Push Service Loading message that has been modified by appending the set of recommended quality of service parameters.

25. The network node according to claim 21, wherein said service indicating message is a WAP Push Service Indication message that has been modified by appending the set of recommended quality of service parameters.

26. The network node according to claim 21, wherein said network node is arranged to push said service indicating message to the first client terminal over a pre-established primary Packet Data Protocol Context and wherein said set of recommended quality of service parameters is a set of recommended Packet Data Protocol Context quality of service parameters for a secondary Packet Data Protocol Context.

27. The network node according to claim 21, wherein the information that the service provider has a service content to deliver to the terminal comprises a Uniform Resource Identifier, URI, indicating the service content.

28. The network node according to claim 21, wherein said set of recommended quality of service parameters comprises an indication to a pre-defined UMTS QoS class.

29. The network node according to claim 21, wherein said set of recommended quality of service parameters comprises a recommended value for at least one UMTS QoS attribute.

30. The network node according to claim 21, wherein said network node is an application server of the service provider.

31. The network node according to claim 21, wherein said network node is a policy server, which is further arranged to check that the service provider is allowed to push the service indicating message to the first client terminal.

32. The network node according to claim 21, wherein said network node is a Push Proxy Gateway which is arranged to create said service indicating message based on a service message received from an application server.

33. A method in a network node in a network for providing a set of packet data services from a service provider to mobile client terminals, said method comprising:
creating a service indicating message for push transmittal to a first client terminal; and
pushing the service indicating message to the first client terminal, wherein the service indicating message includes information that the service provider has a service content to deliver to the first client terminal, the service indicating message including a set of recommended quality of service parameters, which the service provider recommends that the first client terminal requests for a bearer of a bearer service for reception of the service content.

34. The method according to claim 33, further comprising determining said set of recommended quality of service parameters based on at least one of the following types of input information:
type of the service content, type of subscription of the user of the terminal, information about the network in which the bearer service is to be set up, and provider of the service content.

35. The method according to claim 33, wherein said set of recommended quality of service parameters is a set of recommended Packet Data Protocol Context quality of service parameters.

36. The method according to claim 33, wherein said service indicating message is a WAP Push Service Loading message that is modified by appending the set of recommended quality of service parameters.

37. The method according to claim 33, wherein said service indicating message is a WAP Push Service Indication message that is modified by appending the set of recommended quality of service parameters.

38. The method according to claim 33, wherein said service indicating message is pushed to the first client terminal over a pre-established primary Packet Data Protocol Context wherein said set of recommended quality of service parameters is a set of recommended Packet Data Protocol Context quality of service parameters for a secondary Packet Data Protocol Context.

39. The method according to claim 33, wherein the information that the service provider has a service content to deliver to the terminal comprises a Uniform Resource Identifier, URI, indicating the service content.

40. The method according to claim 33, wherein said set of recommended quality of service parameters comprises an indication to a pre-defined UMTS QoS class.

41. The method according to claim 33, wherein said set of recommended quality of service parameters comprises a recommended value for at least one UMTS QoS attribute.

42. The method according to claim 33, wherein said method further includes checking if the service provider is allowed to push the service indicating message to the first client terminal by means of checking a pre-determined policy.
